(19) United States
(12) Patent Application Publication
(10) Pub. No.: US 2002/0017415 A1
(43) Pub. Date: Feb. 14, 2002

(54) Method and apparatus for anticipating a vehicle crash event

(75) Inventors: Doug P. Campbell, Metamora, MI (US); Gregory S. Bayley, Dryden, MI (US)

Correspondence Address: Tarolli, Sundheim, Covell, Tummino & Szabo L.L.P., 1111 Leader Building, 526 Superior Avenue, Cleveland, OH, 44114-1400, US

(73) Assignee: TRW Vehicle Safety Systems Inc.

(21) Appl. No.: 09/952,111

(22) Filed: Sep. 14, 2001

Related U.S. Application Data
(63) Continuation of application No. 09/211,702, filed on Dec. 14, 1998, now abandoned.

(51) Int. Cl. B60L 3/00

(52) U.S. Cl. 180/271; 280/728.1

(57) ABSTRACT

An occupant protection system (10) for a vehicle (12) includes a receiver (24) which is operative to receive a vehicle position signal (30) from a source (34) of positioning information. The receiver (24) also is operative to receive an object signal (38) indicative of the speed and position of an object adjacent the vehicle. The system (10) includes a vehicle speed sensor (90) which is operative to provide a vehicle speed signal (92) indicative of the speed of the vehicle. A controller (22) is electrically coupled with the receiver (24) and the vehicle speed sensor (90). The controller (22) is operative to provide an anticipatory crash event signal (99, 101, 103, 105, 107, 109 and/or 111) upon determining the occurrence of an anticipatory crash event condition in response to the vehicle position signal (30), the vehicle speed signal (92), and the object signal (38).

### TECHNICAL FIELD

The present invention relates to a vehicle occupant protection system for helping to protect a vehicle occupant and, more particularly, to an apparatus and method for anticipating a vehicle crash event.

### BACKGROUND OF THE INVENTION

A typical vehicle occupant protection system is capable of detecting a vehicle crash event only upon detecting a physical impact with the vehicle. Such a system usually has one or more crash event sensors for detecting the occurrence of the vehicle crash event. For example the sensor may be an inertia sensing device, a crush sensing device, and/or an acceleration sensing device. When the sensor or sensors detect the impact, one or more occupant protection devices are actuated to help protect one or more vehicle occupants.

Another type of occupant protection system operates by detecting and measuring the distance between adjacent vehicles. For example, the system may use electromagnetic waves or ultrasonic waves to measure the distance between the vehicle and an adjacent object. The system attempts to prevent the occurrence of a vehicle crash event by activating a warning signal to alert a vehicle occupant when the measured distance indicates an increased risk of a vehicle crash event. Electromagnetic or optical waves, however, cannot readily distinguish between vehicles and other high mass targets which often are located adjacent to roadways. Accordingly, erroneous warning signals can easily occur.

Another type of vehicle occupant protection system relates to a transportation system which controls a following vehicle to maintain it at a predetermined distance behind a preceding vehicle. In addition, such a system controls the steering and speed of the following vehicle so that it follows the path of the preceding vehicle and maintains a safe distance. A necessary consequence of such an approach is to take at least part of the driving control out of the hands of the vehicle driver.

### SUMMARY OF THE INVENTION

The present invention is directed to an occupant protection system for a vehicle. The system includes a receiver which is operative to receive a vehicle position signal from a source of positioning information. The receiver also is operative to receive an object signal indicative of the speed and position of an object adjacent the vehicle, such as another vehicle. The system also includes a vehicle speed sensor which is operative to provide a vehicle speed signal indicative of the speed of the vehicle. A controller is electrically coupled with the receiver and the vehicle speed sensor. The controller also is operative to provide an anticipatory crash event signal upon determining the occurrence of an anticipatory crash event condition in response to the vehicle position signal, the vehicle speed signal, and the object signal.

### BRIEF DESCRIPTION OF THE DRAWINGS

The foregoing and other features of the present invention will become more apparent to one skilled in the art upon consideration of the following description of a preferred embodiment of the present invention and the accompanying drawings in which:

FIG. 1 is a schematic representation of a vehicle occupant protection system in accordance with a preferred embodiment of the present invention;

FIG. 2 is a schematic representation of part of FIG. 1; and

FIG. 3 is a flow diagram illustrating a method in accordance with a preferred embodiment of the present invention.

### DESCRIPTION OF A PREFERRED EMBODIMENT

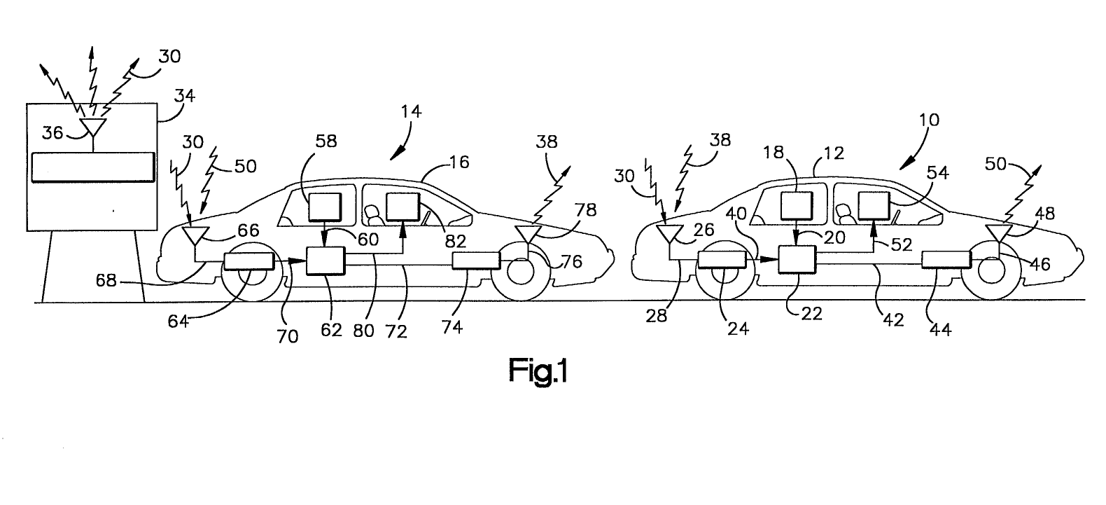

FIG. 1 schematically illustrates an occupant protection system 10 installed in a first vehicle 12. Another occupant protection system 14 is installed in an adjacent object, such as a second vehicle 16. It will be understood and appreciated that, alternatively, the second system 14 might be part of another type of moveable object or a stationary object, such as a highway abutment, a sign, or other high mass object which might be located adjacent a roadway.

The systems 10 and 14 communicate with each other so that the occurrence of a vehicle crash event between the first and second vehicles 12 and 16 may be anticipated. By anticipating a vehicle crash event, actuation of various occupant protection devices, such as inflatable air bags and actuatable seat belt devices, may be controlled.

The system 10 of the first vehicle 12 includes vehicle condition circuitry 18. The vehicle condition circuitry 18 provides at least one signal 20 indicative of at least one predetermined vehicle condition to a microcontroller 22. The vehicle condition sensing circuitry 18 may include, for example, a vehicle speed sensor and a conventional crash event sensor, such as an accelerometer or an inertia sensing device, a crush sensor or an impact sensing device.

It will be understood that the microcontroller 22 preferably includes a microprocessor programmed to determine the occurrence of a vehicle crash event as well as to control one or more occupant protection devices. The microcontroller 22 may be in any form, such as, for example, one or more integrated circuits, a plurality of discrete components, or a combination of appropriately configured integrated circuits and discrete components.

The system 10 also includes a receiver 24 connected with an antenna 26 through a suitable electrical connection 28. The combination of the antenna 26 and receiver 24 receives signals 30 and 38. Preferably, the signals 30 and 38 are radio frequency (RF) signals of a predetermined frequency. The signals 30 and 38 could be transmitted over free space in any form capable of containing useful information, such as in the form of electromagnetic waves, sound waves etc. The particular signal form or frequency is a matter of design choice. In addition, the signals may be the same or different types of signals.

One signal 30 is transmitted, suitably as a periodic broadcast, from a source 34 of location or position information. The source 34 of position information includes an appropriate antenna 36 from which the position signal 30 radiates. While in the preferred embodiment of FIG. 1, the source 34 of the position information signal 30 is shown as a terrestrial beacon, it will be understood and appreciated that a satellite-based system, such as a conventional Global Positioning System (GPS), also could be used. It further will be appreciated that a vehicle location system using a cellular telephone network, such as disclosed in U.S. Pat. No. 5,208,756, also could be used. Because these and other position sensing systems may be used in accordance with the present invention, the position information simply is described as being contained within the position signal 30. The position of the vehicle 10 is determined from the position signal 30, suitably by the microcontroller 22.

The receiver 24 also receives an object signal 38 which contains information indicative of a condition of another object, such as vehicle condition information of the adjacent vehicle 16. As described below, the vehicle condition information of the signal 38 is sufficient for the system 10 to determine the instantaneous position, speed and/or path of travel for the vehicle 16. When an object, such as the vehicle 16, is stationary, the speed value for the object is zero and thus its path corresponds to a point having a constant position.

The receiver 24 includes suitable circuitry for filtering, amplifying and modulating the received signals 30 and 38 for use by the microcontroller 22. The receiver 24 provides to the microcontroller 22 at least one processed signal 40 which corresponds to both of the received signals 30 and 38.

The microcontroller 22 provides a signal 42 to a transmitter 44 which contains information indicative of the vehicle condition of the first vehicle 12. The vehicle condition signal 42, for example, contains information identifying an instantaneous vehicle speed of the vehicle 12 as well as information identifying an instantaneous position of the vehicle 12, such as determined from the position signal 30. The condition signal 42 also might indicate a path of travel for the vehicle 12 based on a plurality of previous position data and the most recent position information received from the source 34. The position information may be stored in suitable memory associated with the microcontroller 22.

The transmitter 44 contains circuitry to modulate the vehicle condition signal 42 and to provide the modulated signal 46 to an antenna 48. The antenna 48, in turn, broadcasts a vehicle condition signal 50 which may be received by one or more occupant protection systems, such as the system 14 of the vehicle 16 located adjacent to the vehicle 12. Preferably, the vehicle condition information of the signal 50 is updated at a sufficient rate so as to provide substantially instantaneous vehicle condition information to the system 14 of the adjacent vehicle 16.

The microcontroller 22 also is configured to determine whether an anticipatory crash event condition exists. In general, an anticipatory crash event condition exists where, based upon a comparison of the current relative position and speed of the vehicle 12 and the current relative position and speed of the vehicle 16, the probability of a vehicle crash event between the vehicles 12 and 14 is greater than some threshold value. That is, a vehicle crash event is imminent.

The microcontroller 22 also is effective to control actuation of at least one actuatable occupant protection device 54. Upon determining the existence of a vehicle crash event condition, the microcontroller 22 provides a control signal 52 to the protection device 54. This causes actuation of the protection device 54 to help cushion and/or restrain a vehicle occupant during a vehicle crash event. Examples of suitable occupant protection devices 54 are described below.

The occupant protection system 14 of the second vehicle 16 is substantially identical to the system 10 of the first vehicle 12. The system 14 includes vehicle condition circuitry 58 which provides a signal 60 indicative of at least one predetermined vehicle condition to a microcontroller 62. The vehicle condition sensing circuitry 58 preferably includes at least a vehicle speed sensor and a crash event sensor, both of which are known in the art.

The system 14 also includes a receiver 64 connected with an antenna 66 through a suitable electrical connection 68. The antenna 66 receives signals 30 and 50, as described above. The signal 30 is transmitted from the source 34 of position information. The system 14 determines the position of the vehicle 16 upon receiving the signal 30. The receiver 64 also receives the condition signal 50, which contains position and speed information for at least one adjacent object, such as the vehicle 12.

The receiver 64 is substantially identical to the receiver 24 of the previously described system 10. The received signals 30 and 50 are appropriately filtered, amplified and demodulated. The receiver 64 provides to the microcontroller 62 a signal 70 corresponding to the received signals 30 and 50. The microcontroller 62 is configured to determine whether an anticipatory crash event condition exists.

The microcontroller 62 also provides a signal 72 to a transmitter 74 which contains information indicative of the vehicle condition of the second vehicle 16. The vehicle condition signal 72 preferably contains information identifying at least an instantaneous vehicle speed of the vehicle 16 as well as information indicative of an instantaneous position of the vehicle. The vehicle condition signal 72 also might contain information indicating the path of the vehicle 16 as determined by the microcontroller 22 based upon current and previous vehicle condition information. The transmitter 74 modulates the vehicle condition signal 72 to an appropriate frequency signal 76 and supplies the modulated signal 76 to an antenna 78 for broadcasting of the vehicle condition signal 38. The signal 38 may be received by other occupant protection systems, such as the system 10 of the vehicle 12.

The microcontroller 62 also is effective to provide a control signal 80 to one or more occupant protection devices 82. This helps to cushion and/or restrain a vehicle occupant upon determining the existence of a vehicle crash event condition.

It will be appreciated by those skilled in the art that each occupant protection system 10 and 14 communicates vehicle condition information, preferably including vehicle speed and relative vehicle position. The vehicle condition information signals 38 and 50 may be received by another system located within range of the respective system transmitters 44 and 74. It further will be appreciated that instead of each system having a separate transmitter and receiver, a system in accordance with the present invention may utilize a transceiver capable of both transmitting and receiving the appropriate data signals.

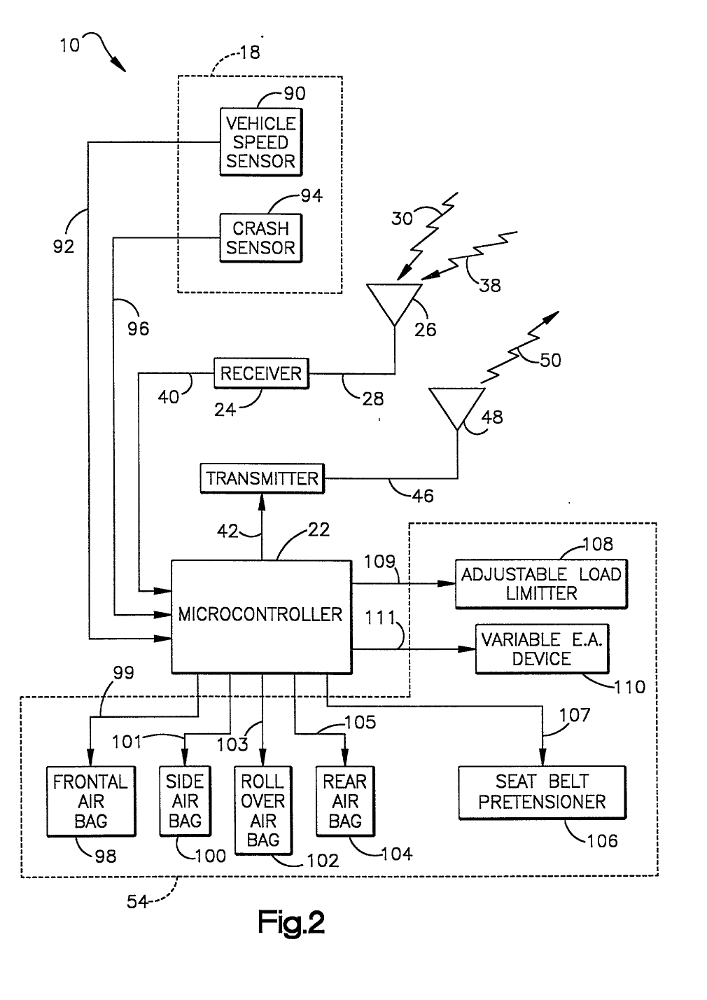

FIG. 2 illustrates the system 10 of FIG. 1 in accordance with a preferred embodiment of the present invention. In this embodiment, the vehicle condition circuit 18 includes a vehicle speed sensor 90 which provides to the microcontroller 22 a vehicle speed signal 92 having an electrical characteristic indicative of vehicle speed. The vehicle speed sensor 90 may be part of a conventional speedometer of the vehicle 12. Alternatively, the vehicle speed sensor 90 may be a separate electronic component operative to monitor the rotation of a vehicle wheel and thereby provide a signal indicative of the vehicle's speed. The informational content of the signal 92 may be processed by the sensor 90 to provide a value indicative of the vehicle speed. Alternatively, the signal 92 may simply contain a value which is processed by the microcontroller 22 for a determination of the instantaneous vehicle speed.

The vehicle condition circuit 18 also includes a crash event sensor 94, which is effective to provide to the microcontroller 22 a signal 96 having an electrical characteristic indicative of the occurrence of a vehicle crash event. Preferably, the crash sensor 94 includes at least one acceleration sensing device, such as an accelerometer. Alternatively or in addition to an acceleration sensing device, the crash sensor 94 may include an inertia sensing device, a crush sensor, and/or a vehicle rollover sensor.

The microcontroller 22 is configured to determine the occurrence of a vehicle crash event in response to the crash sensor signal 96. Any known control algorithm, suitably selected according to the type(s) of crash sensor(s) and vehicle platform, may be used to determine the occurrence of a vehicle crash event.

The microcontroller 22 also is operative to determine the occurrence of an anticipatory vehicle crash event. In particular, the microcontroller 22 determines a first vehicle path for the vehicle 12 in which the system 10 is installed. The first vehicle path is determined upon the microcontroller 22 receiving the position signal 30 from the source 34 of position information and the vehicle speed signal 92 from the vehicle speed sensor 90. Preferably, the microcontroller 22 stores the path information and/or previous vehicle speed and position information in appropriate memory.

Preferably, the first vehicle path is determined based upon previous vehicle position information and speed information for the vehicle 12 as well as the most recent instantaneous speed and position information. The microcontroller 22 suitably extrapolates from the previous and instantaneous data to determine an anticipated path or trajectory for the vehicle 12.

The microcontroller 22 also is operative to determine an anticipated path for an object located adjacent to the vehicle 12, such as the second vehicle 16. In FIG. 1, the second path is determined upon receiving the vehicle condition signal 38 from the vehicle 16. Specifically, the receiver 24 receives the broadcast vehicle condition signal 38 from the second vehicle 16 and provides the corresponding receiver signal 40 to the microcontroller 22. It will be understood and appreciated that the internal relative position information of the vehicle 12 and the vehicle condition information of adjacent vehicle 16 may be provided to the microcontroller 22 by more than one line from the receiver 24.

The vehicle condition information of the second vehicle 16 preferably contains the same types of data used to calculate the first vehicle path, namely position information and speed information for the second vehicle. Alternatively, the microcontroller 62 of the second vehicle 16 might calculate and transmit the vehicle condition signal 38 indicating its own path. The microcontroller 22 determines an anticipated vehicle path for the second vehicle 16, which may be extrapolated from the instantaneous and previous vehicle condition data of the second vehicle. The microcontroller 22 compares the anticipated vehicle path of the first vehicle 12 with the anticipated vehicle path of the second vehicle 16 to determine whether an anticipatory crash event condition exists.

The microcontroller 22 also is operative to control at least one and preferably a plurality of actuatable occupant protection devices 54 to help cushion and/or restrain a vehicle occupant upon determining the existence of a vehicle crash event. The protection devices 54 are actuatable upon determining the occurrence of an impact-responsive vehicle crash event, suitably based upon the crash sensor signal 96. The protection devices 54 also are actuatable upon determining the existence of an anticipatory crash event condition.

The protection devices 54 include one or more inflatable occupant protection devices and/or a variety of seat belt restraining mechanisms to help protect a vehicle occupant during a vehicle crash event. The occupant protection devices 54 may include, for example, a front air bag 98, a side air bag 100, a rollover air bag 102, a rear air bag 104, a seat belt pretensioner device 106, an adjustable load limiter 108, a variable energy absorbing device 110 or any other suitable occupant protection device.

Depending upon the anticipated severity and direction of the anticipated crash event, the microcontroller 22 controls actuation of one or any number of the protection devices 98, 100, 102, 104, 106, 108 and 110 through respective control signals 99, 101, 103, 105, 107, 109, and 111. Such control signals 99, 101, 103, and 105 may indicate, for example, the amount of inflation and/or time of actuation for the inflatable occupant protection devices 98, 100, 102 and 104. Similarly, the control signals 107, 109, and 111 might control the timing and/or amount of restraining force provided by the seat belt restraint mechanisms 106, 108 and 110.

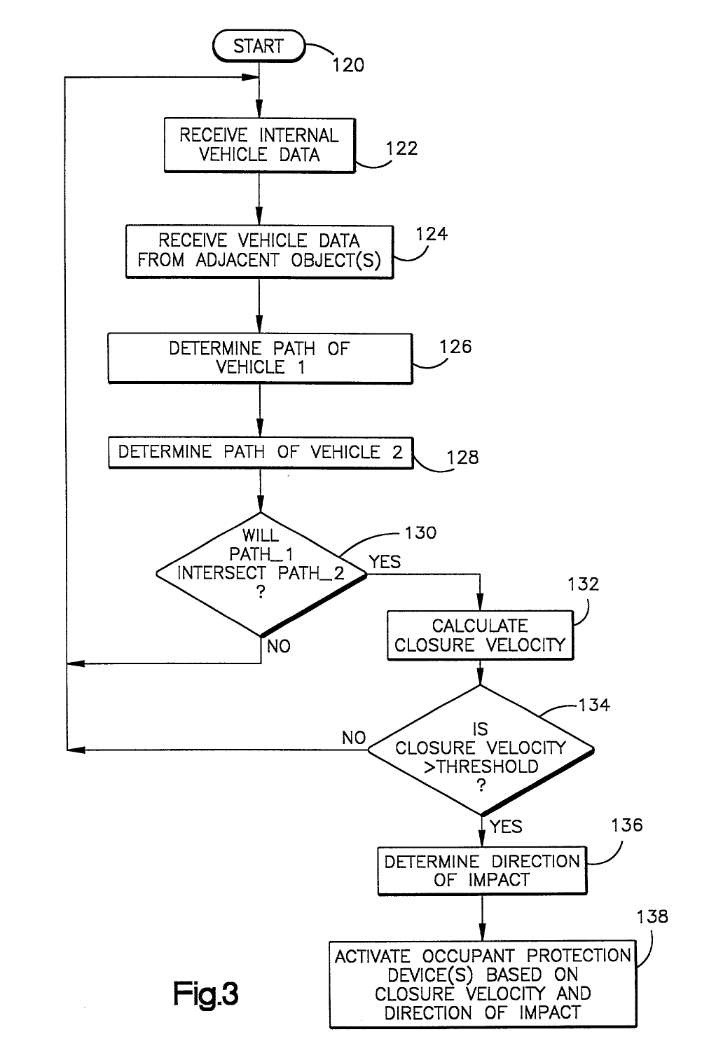

FIG. 3 illustrates a preferred manner of operation for the system 10 of FIG. 2. The system 10 begins operating at step 120 upon, for example, such as upon turning on a vehicle ignition switch of the vehicle 12. The microcontroller 22 and other system components are initialized and internal memories, flags, initial conditions, etc., are set to initial values. Once activated, the microcontroller 22 is effective to receive internal vehicle condition data (step 122) indicative of the speed of the vehicle 12 and the position of the vehicle. As stated above, the internal vehicle speed sensor 90 provides the speed signal 92 to the microcontroller 22 and the receiver 24 provides the receiver signal 40 to the microcontroller, which signal includes instantaneous relative position data.

The microcontroller 22 also receives condition data from one or more adjacent objects (step 124), such as the vehicle condition data of the signal 38 from the vehicle 16 (FIG. 1). In the preferred embodiment of FIGS. 1 and 2, the signal 38 is received at the antenna 26. The receiver 24 demodulates the received signal and provides the vehicle condition data to the microcontroller 22 as part of the receiver signal 40.

Upon receiving the internal vehicle condition data (step 122), the microcontroller 22 determines the path of the first vehicle 12 (step 126). Preferably, the path of the first vehicle 12 is a function of the vehicle's speed and its relative position. Similarly, the microcontroller 22 determines the path of one or more adjacent objects (step 128), such as the vehicle 16. The path of the adjacent vehicle is determined as a function of the vehicle condition data, which preferably includes the vehicle speed and the relative position of each such adjacent object or vehicle, such as described above.

It will be appreciated by those skilled in the art that the particular order in which the vehicle paths are determined may be different from that just described. For example, the microcontroller 22 may determine the path of the first vehicle prior to receiving the vehicle data of the adjacent vehicle or vehicles. It also will be appreciated that, in certain circumstances, no vehicle data will be received from an adjacent vehicle. In this situation, the microcontroller 22 will not determine the path for any adjacent object. The adjacent object also may have a zero speed value indicative of a stationary object which has a path defined by a point. Furthermore, as the paths of the first vehicle 12 and an adjacent vehicle diverge, the adjacent vehicle eventually will be out of range and, thus, the system 10 may not be able to receive the condition signals from the diverging vehicle.

Assuming that the second vehicle 16 is within range of the first vehicle 12, the process proceeds and the microcontroller 22 determines whether the first path will intersect with the second path (step 130). If the paths do not intersect, the process returns to step 122 where the vehicle condition data is updated. The path data of the respective vehicles 12 and 16 also is updated according to new vehicle condition data.

If the microcontroller 22 determines that the first path of the first vehicle 10 will intersect the second path of an adjacent object, the microcontroller 22 calculates a relative closure velocity (step 132). In general, the closure velocity is the rate at which the relative distance between the first vehicle 12 and each adjacent object decreases, e.g. a sum of the instantaneous velocity of the vehicle 12 and instantaneous velocity of the adjacent object. Preferably, this is based upon a comparison of the vehicle condition data for the first vehicle 12 and the condition data for the adjacent object, such as the vehicle 16.

It will be understood and appreciated by those skilled in the art that the system 10 is configured to be responsive to more than one adjacent object. For example, if more than one object, including vehicles, is adjacent to the first vehicle 12 and a determination is made that the path of the first vehicle will intersect with each such object, the microcontroller 22 will proceed to determine a closure velocity for each such potentially intersecting adjacent object.

The microcontroller 22 next determines whether the closure velocity exceeds a predetermined threshold velocity (step 134). A suitable threshold velocity may be determined experimentally for a particular vehicle in which the system will be installed to provide for a desired level crash discrimination.

While FIG. 3 illustrates a single closure velocity threshold, it will be understood and appreciated by those skilled in the art that a plurality of such closure velocity thresholds may be used to provide for and facilitate variable control of the actuatable occupant protection devices 98, 100, 102, 104, 106, 108, and 110 of FIG. 2.

If the closure velocity does not exceed the predetermined threshold, the process returns to step 122 to update the vehicle condition data and recalculate the vehicle paths.

Provided that the closure velocity exceeds the threshold value, the microcontroller 22 then determines a relative direction for the anticipated impact (step 136) between the first vehicle 12 and the adjacent object. For the example of FIG. 1, the relative direction of anticipated impact is determined based upon the respective paths of the vehicles 12 and 16. The relative direction of impact indicates from which direction and at what angle the adjacent object will strike the first vehicle 12. The microcontroller 22 thus may determine which part of the vehicle body will collide with the adjacent object.

Depending upon the calculated relative direction of impact, the microcontroller 22 then proceeds to actuate one or more of the actuatable occupant protection devices 98, 100, 102, 104, 106, 108, and 110 (step 138) selectively. Preferably, the selection of the protection devices 98, 100, 102, 104, 106, 108, and 110 will be based upon the closure velocity and the relative direction of impact determined by the microcontroller 22. The actuation of the protection devices 98, 100, 102, 104, 106, 108, and 110 also may be controlled so as to provide variable amounts of cushioning or restraint, based upon the closure velocity and/or relative direction of impact parameters.

For example, upon determining an anticipatory crash event between the first vehicle 12 and an adjacent object in a head-on collision, the microcontroller 22 may control actuation of the seat belt pretensioner 106, the variable energy absorbing device 110, and/or the frontal air bag 98 to restrain and cushion an occupant or occupants of the first vehicle. Similarly, where the relative direction of impact is determined to be transverse to the first vehicle 12, such as during a side impact vehicle crash event, the microcontroller 22 may control activation of the side air bag 100 and the seat belt pretensioner device 106 to help protect one or more vehicle occupants of the first vehicle. In addition, the microcontroller 22 may vary the amount of inflation and/or restraint provided by the occupant protection devices 98, 100, 102, 104, 106, 108, and 110 depending upon the anticipated crash event parameters, e.g. closure velocity and relative direction of anticipatory impact.

In view of the foregoing, it will be appreciated that the system of the present invention anticipates a vehicle crash event and controls actuation of associated actuatable occupant protection devices 98, 100, 102, 104, 106, 108, and 110, preferably according to the relative paths of the vehicles involved in the crash event. When operating in the anticipatory mode based upon received signals 30 and 38 and the internal vehicle condition signals 92 and 96, an activation signal 99, 101, 103, 105, 107, 109, or 111 to one or more of the occupant protection devices 98, 100, 102, 104, 106, 108, or 110, respectively, may be provided earlier than with most conventional systems. This advantageously enables effective use of slow onset or multiple stage inflation systems.

In addition to determining an anticipated crash event based upon the vehicle paths, a system in accordance with the present invention also is operative for use in combination with conventional non-anticipatory crash sensors, such as the crash sensor 94 (FIG. 2). This is advantageous for situations when the adjacent object or objects involved in a crash event do not have such an anticipatory crash event system or are otherwise unable to transmit condition signals for receipt by the system 10.

It will be understood and appreciated that stationary objects which might be subjected to crash event with a vehicle also may be equipped with a transmitter to provide position information to protection systems. The system 10 could use such transmitted position information to determine an anticipatory crash event with such an adjacent object. Accordingly, the system could more effectively control actuation of pertinent occupant protection devices upon determining the vehicle path intersecting with the location of the stationary object.

From the above description of the invention, those skilled in the art will perceive improvements, changes and modifications. Such improvements, changes and modifications within the skill of the art are intended to be covered by the appended claims.

Having described the invention, the following is claimed:

1. A vehicle occupant protection system comprising:
a receiver which is operative to receive a vehicle position signal from a source of positioning information, said receiver also being operative to receive an object signal indicative of the speed and position of an object adjacent to the vehicle;
a vehicle speed sensor which is operative to provide a vehicle speed signal indicative of the speed of the vehicle; and
a controller electrically coupled with said receiver and said vehicle speed sensor, said controller being operative to provide an anticipatory crash event signal upon determining the occurrence of an anticipatory crash event condition in response to the vehicle position signal, the vehicle speed signal, and the object signal.

2. A system as set forth in claim 1 wherein the object is another vehicle.

3. A vehicle occupant protection system comprising:
a receiver which is operative to receive a vehicle position signal from a source of positioning information and an object signal indicative of a speed condition and a position condition of at least one object adjacent the vehicle;
a vehicle speed sensor which is operative to provide a vehicle speed signal indicative of the speed of the vehicle; and
a controller electrically coupled with said receiver and said vehicle speed sensor, said controller being operative to determine a first vehicle path upon receiving the position signal from the source of positioning information and the vehicle speed signal from the vehicle speed sensor, said controller being operative to determine a second object path upon receiving the object signal, said controller providing an anticipatory crash event signal upon determining the occurrence of an anticipatory crash event condition upon determining the first vehicle path and the second object path.

4. A system as set forth in claim 3 further including at least one vehicle occupant protection device which, when actuated, helps to protect a vehicle occupant during a vehicle crash event, said controller being operative to control actuation of said at least one vehicle occupant protection device in response to the anticipatory crash event signal.

5. A system as set forth in claim 3 further including a transmitter for broadcasting another signal for receipt by at least one adjacent vehicle upon receiving the position signal from the source of position information and the vehicle speed signal from the vehicle speed sensor.

6. A system as set forth in claim 3 wherein said controller is operative to determine a closure velocity between the vehicle and the at least one object based upon the first vehicle path and the second object path, the anticipatory crash event signal varying as a function of the closure velocity.

7. A system as set forth in claim 3 wherein said controller is operative to determine a relative direction of anticipatory impact between the vehicle and the at least one object based upon the first vehicle path and the second object path, the anticipatory crash event signal varying as a function of the relative direction of anticipatory impact.

8. A system as set forth in claim 7 further including at least one vehicle occupant protection device responsive to the anticipatory crash event signal which, upon being actuated in response to the anticipatory crash event signal, helps to protect a vehicle occupant during a vehicle crash event.

9. A system comprising:
a plurality of anticipatory sensing apparatuses, each apparatus of said plurality of apparatuses being mountable in an associated vehicle and including:
a receiver for receiving a first signal indicative of vehicle position for the vehicle associated with a first apparatus of said plurality of apparatuses and for receiving a second signal from a second apparatus of said plurality of apparatuses, the second signal being indicative of vehicle condition information of the vehicle associated with said second apparatus, the vehicle condition information of the second signal including vehicle speed and vehicle position of the vehicle associated with said second apparatus,
a transmitter for transmitting a third signal indicative of vehicle condition information of the vehicle associated with said first apparatus which may be received by at least another apparatus of said plurality of apparatuses, the vehicle condition information of the third signal including vehicle speed and vehicle position of the vehicle associated with said first apparatus, and
a controller operative to determine an anticipatory crash event condition based upon the vehicle condition information of the vehicle associated with said second apparatus and the vehicle condition information of the vehicle associated with said first apparatus, said controller of said first apparatus being operative to control actuation of an actuatable vehicle occupant protection device of the vehicle associated with said first apparatus upon determining the anticipatory crash event condition.

10. A system as set forth in claim 9 wherein said first apparatus further includes a vehicle speed sensor which provides a vehicle speed signal indicative of vehicle speed of the vehicle associated with said first apparatus, said controller of said first apparatus being operative to determine a first vehicle path upon receiving the vehicle speed signal and the first signal, and said controller of said first apparatus being operative to determine a second vehicle path upon receiving the second signal from the vehicle associated with said second apparatus.

11. A system as set forth in claim 10 wherein said controller of said first apparatus is operative to provide an anticipatory crash event signal which varies as a function of the first vehicle path and the second vehicle path.

12. A system as set forth in claim 11 wherein the vehicle associated with said first apparatus includes a plurality of actuatable vehicle occupant protection devices for, when actuated, helping to protect a vehicle occupant of the vehicle associated with said first apparatus during a vehicle crash event, the anticipatory crash event signal of said controller of said first apparatus being effective to control actuation of each of said plurality of actuatable vehicle occupant protection devices.

13. A system as set forth in claim 12 wherein said controller of said first apparatus is operative to determine a closure velocity between the vehicle associated with said first apparatus and the vehicle associated with said second apparatus based upon the first path and the second path, the anticipatory crash event signal varying as a function of the closure velocity.

14. A system as set forth in claim 12 wherein said controller of said first apparatus is operative to determine a relative direction of anticipatory impact between the vehicle associated with said first apparatus and the vehicle associated with said second apparatus based upon the first path and the second path, the anticipatory crash event signal varying as a function of the relative direction of anticipatory impact.

15. A method for helping to protect a vehicle occupant of a vehicle during a crash event, said method comprising the steps of:
receiving a vehicle position signal indicative of the position of the vehicle;
sensing the speed of the vehicle;
providing a vehicle speed signal indicative of the sensed vehicle speed;
determining a vehicle path based upon the vehicle speed signal and the vehicle position signal;
receiving an object signal from at least one adjacent object, the object signal being indicative of the at least one adjacent object's position and speed;
determining an object path of the at least one adjacent object upon receiving the object signal from the at least one adjacent object;
comparing the vehicle path and the object path, and
controlling actuation of an actuatable vehicle occupant protection device based upon the vehicle path and the object path.

16. A method as set forth in claim 15 further including the steps of determining if the vehicle path intersects with the object path and, if the paths intersect, determining a closure velocity between the first vehicle and the at least one adjacent object.

17. A method as set forth in claim 16 further including the steps of determining a relative direction of anticipatory impact between the vehicle and the adjacent object based upon the vehicle path and the object path, and controlling actuation of the occupant protection device of the vehicle based upon the closure velocity and the relative direction of anticipatory impact.
